(19) United States
(12) Patent Application Publication
(10) Pub. No.: US 2014/0194207 A1
(43) Pub. Date: Jul. 10, 2014

(54) GAME SYSTEM PROVIDING CUSTOM GAME STORIES

(71) Applicant: Zynga Inc., San Francisco, CA (US)

(72) Inventors: Adam Ja Ming Yim, San Francisco, CA (US); Abhinav Agrawal, San Francisco, CA (US); Heather A. Sinclair, San Francisco, CA (US)

(73) Assignee: Zynga Inc., San Francisco, CA (US)

(21) Appl. No.: 14/151,353

(22) Filed: Jan. 9, 2014

Related U.S. Application Data
(60) Provisional application No. 61/750,579, filed on Jan. 9, 2013.

(51) Int. Cl. G07F 17/32

(52) U.S. Cl. CPC G07F 17/3272
USPC 463/40

(57) ABSTRACT

A system, computer-readable storage medium storing at least one program, and a computer-implemented method for surfacing game stories are presented. Embodiments may, responsive to detecting a first game action initiated by a first user, surface a first game story to a second user through a social feed. Responsive to detecting that the first game story is activated by the second user, a second game story is surfaced on the social feed that tags the first user. The second game story represents a second game action is performed in a game involving the second user based on the first game story being activated.

### CROSS REFERENCE TO RELATED APPLICATIONS

This application claims priority from U.S. Provisional Application No. 61/750,579, filed Jan. 9, 2013, entitled “GAME SYSTEM PROVIDING CUSTOM GAME STORIES,” all of which is incorporated herein by reference in its entirety for all purpose.

### TECHNICAL FIELD

The subject matter disclosed herein generally relates to the processing of data. Specifically, the present disclosure addresses systems and methods to generate custom game stories.

### BACKGROUND

In traditional systems, a social networking site (e.g., FACEBOOK®) may host third party applications or otherwise provide connections and interfaces (e.g., social graph data) to third party applications. For example, in many traditional systems, a social networking site may provide a platform in which users of the social network may launch and play through the social networking site. As another example, a social networking site may expose an interface that allows a third party game to pull in profile data relating to a player and a social graph for that player (e.g., the connections that that player has with other members of the social network site).

In such traditional systems, the third party application may communicate status updates to the social networking site. In some embodiments, the status updates may indicate user activity occurring with the third party application. Such status updates may, for example, provide status updates that specify that a user has taken a picture, visited a geographical location, liked a post, made a comment, or any suitable action.

### BRIEF DESCRIPTION OF THE DRAWINGS

Some embodiments are illustrated by way of example and not limitation in the figures of the accompanying drawings.

FIG. 1 is a system diagram illustrating an example of a gaming environment for implementing various example embodiments.

FIG. 2 is a diagram showing an example of a social network within a social graph, according to an example embodiment.

FIG. 3 is a block diagram depicting various modules, in accordance with example embodiments, that may be included in a processing system.

FIG. 4 is a sequence diagram illustrating a method of surfacing game stories, according to example embodiments.

FIG. 5 is a user interface diagram that illustrates game user interface for displaying game stories relating to a game at a first instance in time, according to an example embodiment.

FIG. 6 is a user interface diagram that illustrates game user interface for displaying game stories relating to a game at a second instance in time, according to an example embodiment.

FIG. 7 illustrates an example data flow between example components of an example system, according to an example embodiment.

FIG. 8 illustrates an example network environment, in which various example embodiments may operate.

FIG. 9 illustrates an example computing system architecture, which may be used to implement a server or a client system, according to some example embodiments.

### DETAILED DESCRIPTION

Example methods and systems are directed to game stories generated by an online application, such as online games. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The term “game story,” as used herein, may refer to any suitable status update that an online application generates and then surfaces to an online community through a social network platform, such as FACEBOOK®. In some embodiments, a game story may be communicated through a structured, typed application programming interface provided by the social network platform. In some embodiments, a game story may include data that specifies one or more of: an actor, an application, an action, and an object. In some cases, the data of the game story may conform to data types defined by a developer of the online application. In additional or alternative cases, the data of the game story may conform to data types defined by the social network platform.

The social network platform may surface a game story in a display area provided by a social network platform. For example, FACEBOOK® may surface the game story on a news feed, timeline, ticker, or some combination thereof. In some embodiments, the game story may be surfaced in more than one social network platform, such as may be offered by the online application, such as ZYNGA.com®. The social networking platform may aggregate multiple game stories based on multiple game stories according to common or related game objects or game actions.

For clarity of description, example embodiments of a game system providing game stories are described as generating story relationships between multiple game stories. By way of example and not limitation, a game system may surface a first game story through a social networking platform. The first game story may relate to a game action performed by a first player. Responsive to detecting that a second player selected or otherwise activated the first game story through the social networking platform, the game system may surface a second game story, sometimes referred herein as a “response game story,” relating the second player selecting the first game story. The response game story may include a tag that represents the first player.

In some example embodiments, a game system may provide a throttling engine to limit or otherwise control the number of game stories that a player receives. In some cases, the throttling engine may use social data associated with a player to determine whether to surface a game story to a player. In other cases, the throttling engine may use social data of a player to select a group of recipients for a game story.

### Example System

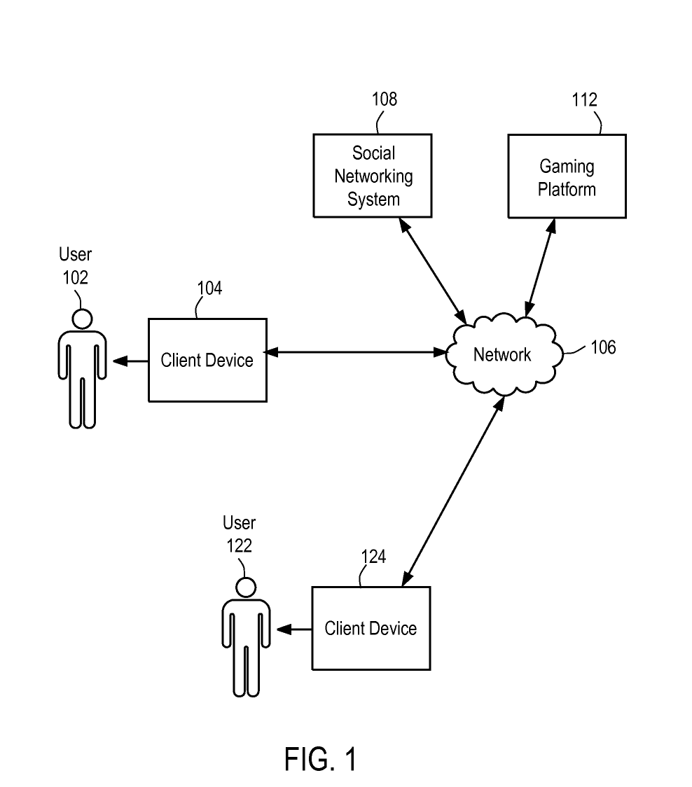

FIG. 1 is a system diagram illustrating an example of a gaming environment 100 for implementing various example embodiments. In some embodiments, the gaming environment 100 comprises users 102, 122, client devices 104, 124, a network 106, a social networking system 108, and a gaming platform 112. The components of the gaming environment 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

Although FIG. 1 illustrates a particular example of the arrangement of the users 102, 122, the client devices 104, 124, the social networking system 108, the gaming platform 112, and the network 106, any suitable arrangement or configuration of the users 102, 122, the client device 104, 124, the social networking system 108, the gaming platform 112, and the network 106 may be contemplated.

The client devices 104, 124 may be computing devices, such as smart phones, personal digital assistants, mobile phones, personal computers, laptops, computing tablets, or any other device suitable for playing a virtual game. The client devices 104, 124 may access the social networking system 108 or the gaming platform 112 directly, via the network 106, or via a third-party system. For example, the client device 104 may access the gaming platform 112 via the social networking system 108.

In some embodiments, the client devices 104, 124 may be communicatively coupled to or include an input device, such as a keyboard, a pointing device, and a display device (not shown). Such input devices may allow a user to interact with a game provided by the gaming platform 112. For example, with the input devices, the client device 104 may allow a user to select (e.g., through a mouse click or a finger tap on a touch screen) a game object.

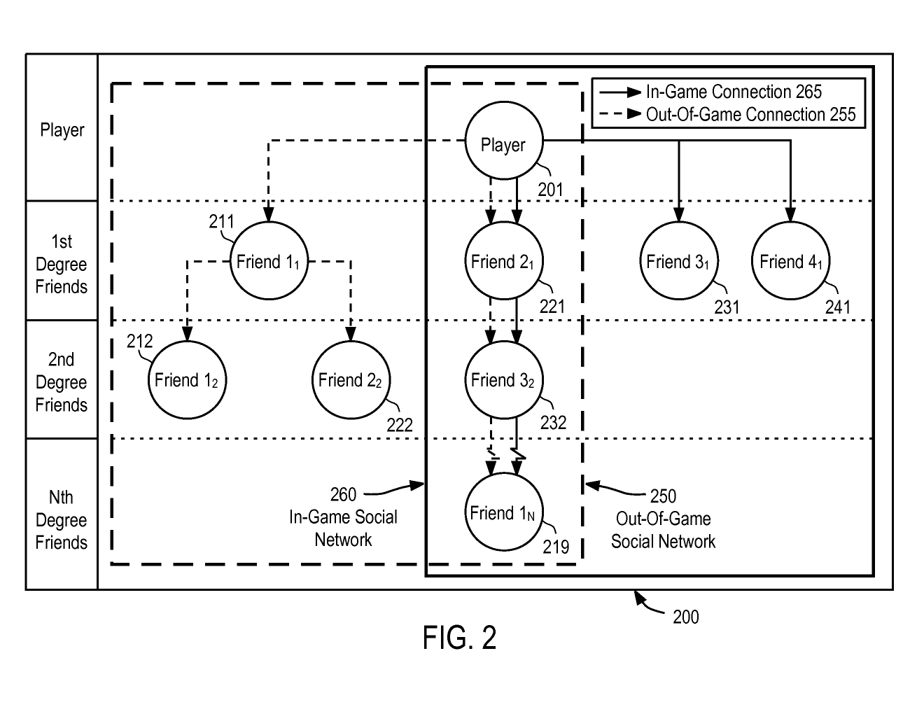

The social networking system 108 may include a network-addressable computing system that can host one or more social graphs (see for example FIG. 2), and may be accessed by the other components of system 100 either directly or via the network 106. The social networking system 108 may generate, store, receive, and transmit social networking data.

FIG. 2 is a diagram showing an example of a social network within a social graph 200, according to an example embodiment. The social graph 200 is shown by way of example to include an out-of-game social network 250 and an in-game social network 260. Moreover, the in-game social network 260 may include one or more users that are friends with Player 201 (e.g., Friend 31 231), and may include one or more other users that are not friends with Player 201. The social graph 200 may correspond to the various users associated with the virtual game. In an example embodiment, player may send game requests to each other. For example, Player 201 may send communication (e.g., a game requests) to Friend 31 231. FIG. 2 and the social graph 200 are described in greater detail below.

With reference back to FIG. 1, the gaming platform 112 may include a network-addressable computing system (or systems) that can host one or more online games. The gaming platform 112 may generate, store, receive, and transmit game-related data, such as, for example, game account data, game input, game state data, and game displays. The gaming platform 112 may be accessed by the other components of the gaming environment 100 either directly or via the network 106. The users 102, 124 may operate the client devices 104, 124, respectively, to access, send, and/or receive data from the social networking system 108 and/or the gaming platform 112.

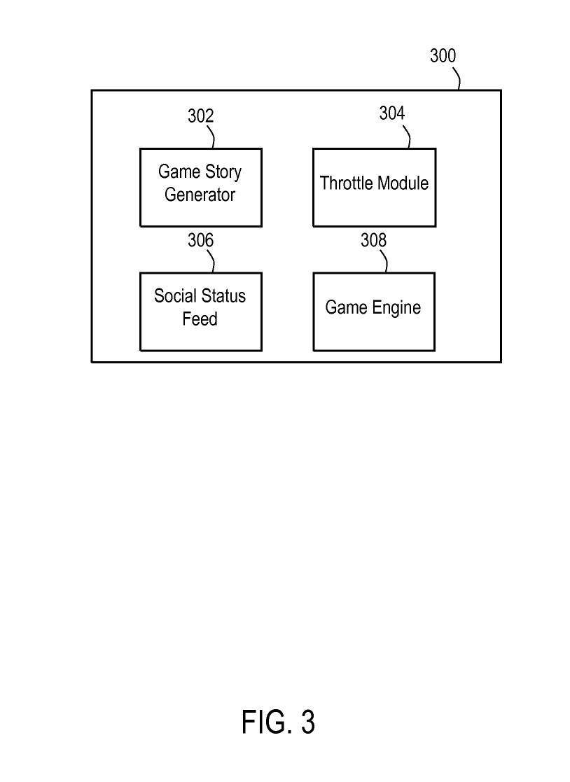

FIG. 3 is a block diagram depicting various modules, in accordance with example embodiments, that may be included in a processing system 300. It should be appreciated that the processing system 300 may be deployed in the form of, for example, a server computer, a client computer, a personal computer, a laptop computer, a mobile phone, a personal digital assistant, and other processing systems. For example, in one embodiment, the processing system 300 may be embodied as the gaming platform 112 of the gaming environment 100 depicted in FIG. 1. In an alternate embodiment, the processing system 300 may be embodied as the client device 104 of the gaming environment 100. As a further example, in yet another embodiment, the modules of the processing system 300 may be a set of computers distributed across both the gaming platform 112 and the client device 104 of the gaming environment 100 depicted in FIG. 1. Referring to FIG. 3, in various embodiments, the processing system 300 may be used to implement computer programs, logic, applications, methods, processes, or software to provide a game action sweep mechanic, as described in more detail below.

As shown in FIG. 3, the processing system 300 may include a game story generator 302, a throttle module 304, a social status feed 306, and a game engine 308. The game story generator 302 may be a computer-implemented module configured to generate game stories based on game actions of a player. Further, in some embodiments, the game story generator 302 may be configured to generate game stories in response to players selecting other game stories. The game story generator 302 may generate relationships between game stories.

The throttle module 304 may be a computer-implemented module configured to limit or otherwise control a group of game stories that a player may send or select. In some embodiments, the throttle module 304 may use social data to limit or control the communication of game stories. For example, the throttle module 304 may determine to surface a social story based on whether social interaction between two players satisfies a throttling criteria.

The social status feed 306 may be a computer-implemented module configured to surface game stories to a social network. For example, social status feed 306 may generate a “News Feed” that aggregates game stories for a social graph associated with a player.

The game engine 308 may be a computer-implemented module configured to control aspects of a game based on rules of the game, including how a game is played, players' actions and responses to players' actions, etc. The game engine 308 may be configured to generate a game instance of a game of a player 102 and may determine the progression of a game based on user inputs and rules of the game.

It should be appreciated that in embodiments different than the example embodiment shown in FIG. 3, the processing system 300 may include fewer, more, or different modules apart from those shown in FIG. 3. For example, in an alternate embodiment, the game story generator 302, the throttle module 304, and game engine 308 may be combined into one module. In another embodiment, the game story generator 302, the throttle module 304, and the game engine 308 can be separate from and executed or processed in parallel to each other.

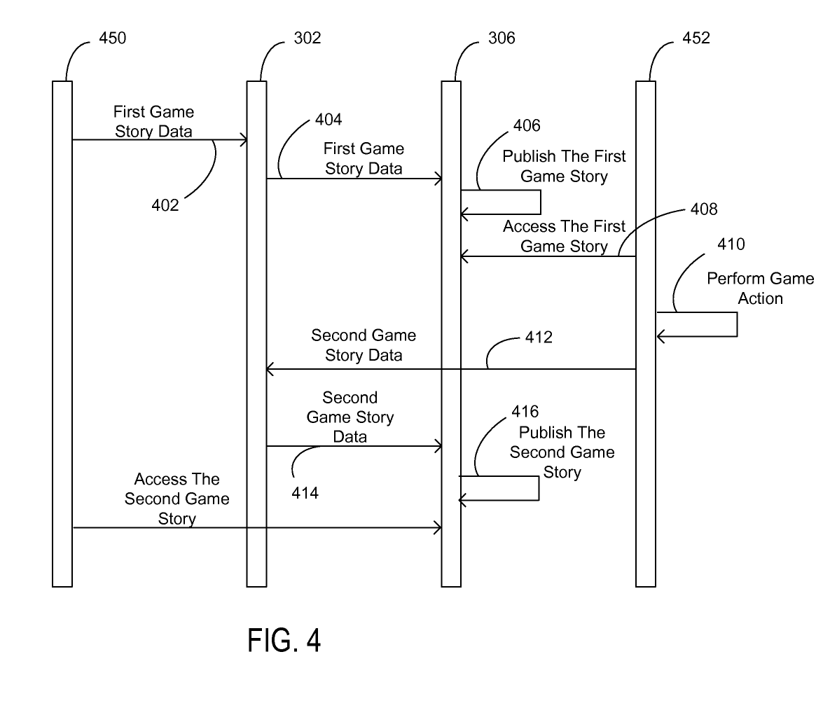

FIG. 4 is a sequence diagram illustrating a method 400 of surfacing game stories, according to example embodiments. The method 400 may be performed by a first game engine 450 operating on a first client device (e.g., the client device 104 shown in FIG. 1), a game engine 452 operating on a second client device (e.g., the client device 124 shown in FIG. 1), the game story generator 302, and the throttle module 304.

Before discussing the operation of the method 400, it is to be appreciated that, according to some embodiments, the first game engine 450 may correspond to a gaming session being played by the user 102 shown in FIG. 1, while the second game engine 452 may correspond to a gaming session being played by the user 122 of FIG. 1. Thus, the first and second game engines 450, 452 can correspond to gameplay corresponding to and initiated by different users.

As shown in FIG. 4, the method 400 may commence at operation 402 when the game story generator 302 obtains first game story data relating to a game action performed with respect to a gaming session being performed by the first game engine 450. In an example embodiment, operation 402 may involve the first game engine 450 detecting that the user 102 has executed a game action that triggers the game engine 450 to generate a game story. A game action may be game logic that represents a request to share a particular game achievement (e.g., growing a prized crop), share a game object (e.g., a reward) with other users in a social network, communicate a request for help within the game, or the like. Accordingly, the first game engine 450 may send the first game story data to the game story generator 302. The first game story data may include a player identifier corresponding to the user 102 (e.g., User1), a game verb data corresponding to a game action (Share), and game object data (Pumpkin) Also, according to some example embodiments, the first game story data may include a game hook that triggers a game action to be performed when activated by other users.

Responsive to obtaining the first game story data relating to the game action involving the user 102, the game story generator 302 may then communicate, at operation 404, the first game story data to the social status feed 306. In some embodiments, communicating the first game story data to the social status feed 306 may involve formatting the first game story data according to an API supported by the social status feed 306. The API supported by the social status feed 306 may process the first game story data to a human readable form. For example, using the parenthetical player identifier, game action, and game object data specified above, the social status feed may represent the first game story data as: “User1 has shared Pumpkins.”

Upon receiving the first game story data, the social status feed 306 may publish the first game story data in the social network. This is shown as operation 406. In some cases, publishing the first game story data may involve surfacing the first game story data to various users of the social network. For example, the social status feed 306 may operate with the FACEBOOK® social network site. In such cases, the social status feed 306 may publish the first game story within a canvas ticker, a homepage ticker, a timeline, a newsfeed, or the like. After the social status feed 306 performs operation 406, the first game story is presented or made accessible to one or more members of the social network (e.g., users belonging to the social graph of the user 102).

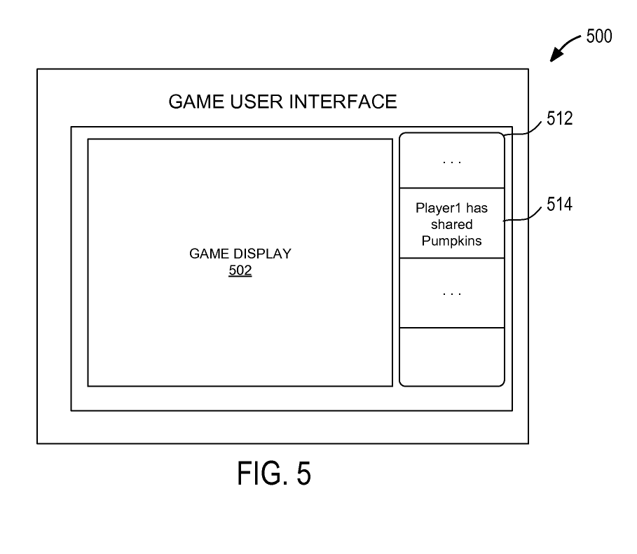

FIG. 5 is a user interface diagram that illustrates game user interface 500 for displaying game stories relating to a game at a first instance in time, according to an example embodiment. The game user interface 500 may be displayed by a game engine (e.g., the first game engine 450 or the second game engine 450). It is to be appreciated that the game user interface 500 may form part of a user interface generated by a social networking service (e.g., Facebook, Twitter, Reddit, Zynga.com, or any other suitable social networking site).

For the purpose of illustration and not limitation, the game user interface 500 may be generated for the user 122 on the client device 124.

As FIG. 5 shows, the game user interface 500 includes a game display 502 and a game story feed 512. The game display 502 may be a user interface element that displays visual images representing game data processed by the game engine. For example, the game display 502 may visually depict a virtual environment (for example, you virtual farm) and other game objects that a player may interact with as part of playing a game.

The game story feed 512 may be a user interface element that displays game stories generated by one or more game engines corresponding to users playing the game posted by the gaming platform 112 of FIG. 1. For example, FIG. 5 shows that the game story feed 512 includes a game story 514 (“Player1 has shared Pumpkins”) By way of example and not limitation, the game story generator 302 may have generated the game story 514 responsive to obtaining game data from the first game engine 450 responsive to the user 102 electing to share game object (e.g., Pumpkins) with a social network. In some cases the game stories displayed by the game story feed 512 may include user interactive elements. For example, in embodiments where the game story generator 302 includes a game action hook with a game story, the game action hook may be activated when the user selects (e.g., clicks) the game story 514.

Thus, the game user interface 500 may be used to surface, to one player (e.g., the user 122), game stories corresponding to game actions performed by other players (e.g., the user 102).

With reference back FIG. 4, at operation 408, the second game engine 452, which may be executing an instance of the game being played by the user 122, may access the first game story. For example, the second game engine 452 may access the first game story responsive to detecting that the second user 122 “clicked” on the first game story that is published by the social status feed 306. In some embodiments, accessing the first game story may cause the second game engine 452 to execute the game hook specified by the first game story. As discussed above, the game hook may cause the game engine 452 to execute game logic of the instance of the game. For example, where the game hook relates to a rewarding game mechanic, the game engine 452 may reward the second user 122 with a game object specified by the first game story.

At operation 410, in response to accessing the first game story, the second game engine 452 may then perform a responding game action associated with the first game story. In an example embodiment, the first game story published by the social status feed 306 may describe a game object that may be awarded to the first user 102. In such embodiments, the responding game action may be a game action that that rewards the user 122 with the game object.

At operation 412, the game story generator 302 may obtain the second game story data relating to the response game action performed by the second game engine 452. In some embodiments, the second game story data may include a player identifier associated with the user 122, a game verb corresponding to the responding game action, a game object corresponding to the game object specified by the first game story. Further, in some embodiments, the second game story data may include tag data that identifies the user that caused the first game story to be generated. For example, the tag data may identify the user 102.

At operation 414, the game story generator 302 may publish the second game story through the social status feed 306. As with publishing the first game story, publishing the second game story data may involve surfacing the second game story data for users of the social network. For example, the social status feed 306 may operate with the FACEBOOK® social network site. In such cases, the social status feed 306 may publish the second game story within a canvas ticker, a homepage ticker, a timeline, a newsfeed, or the like. After the operation 406 is performed, the second game story is presented to the members of the social network.

At operation 416, the first game engine 450 may access the second game story. In some embodiments, the first game engine 450 may access the second game story based at least in part on the first player being tagged in the second game story.

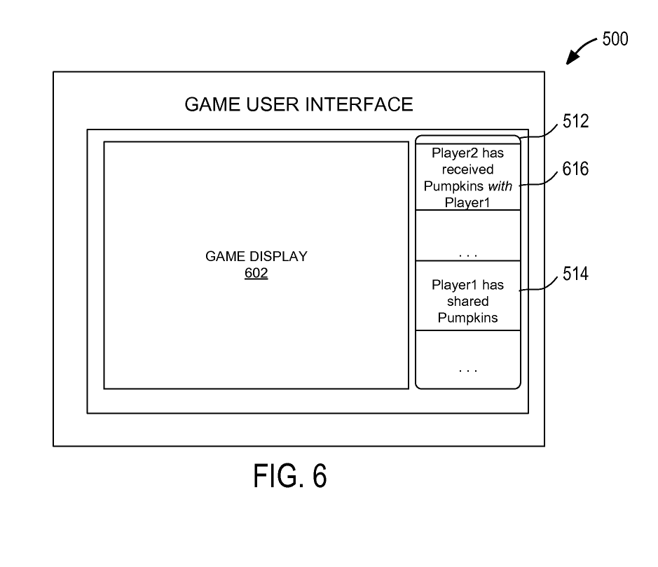

FIG. 6 is a user interface diagram that illustrates game user interface 600 for displaying game stories relating to a game at a second instance in time, according to an example embodiment. For the purpose of illustration and not limitation, the game engine 452 may generate the game user interface 600 for the user 122 on the client device 124, although it is to be appreciated that the game user interface may be generated by any other game engine for any other user. It is to be appreciated that the game user interface 600 also may form part of a user interface generated by a social networking service (e.g., Facebook, Twitter, Reddit, Zynga.com, or any other suitable social networking site).

As FIG. 6 shows, the game user interface 600 includes a game display 602 and a game story feed 612. The game display 602 may be a user interface element that displays visual images representing game data processed by the game engine 450. For example, the game display 602 may visually depict a virtual environment (for example, you virtual farm) and other game objects that a player may interact with as part of playing a game.

The game story feed 612 may be a user interface element that displays game stories generated by one or more game engines corresponding to users playing the game posted by the gaming platform 112 of FIG. 1. For example, FIG. 6 shows that the game story feed 612 includes game story 514 (“Player1 has shared Pumpkins”) and game story 616 (“Player2 has received Pumpkins” with Player1). As described above, by way of example and not limitation, the game story generator 302 may have generated the game story 514 responsive to obtaining game data from the first game engine 450 responsive to the user 102 electing to share game object (e.g., Pumpkins) with a social network. Also described above, in some cases the game stories displayed by the game story feed 512 may include user interactive elements. For example, in embodiments where the game story generator 302 includes a game action hook with a game story, the game action hook may be activated when the user selects (e.g., clicks) the game story 514.

However, compared to the game story feed 512 of FIG. 5, the game story feed 612 includes the game story 616. The game story 616 may correspond to a game story generated based on detecting that the user 112 interacted with the game story 514 shown in the game story feed 512. That is, the game story 616 may be a game story generated in response detecting game actions initiated by one user relative to a prior game story that was, in turn, previously generated responsive to detecting game actions initiated by a second user.

Thus, the game user interface 600 may be used to surface, to one player (e.g., the user 102), game stories corresponding to game actions initiated by another player (e.g., the user 122) with respect to another game story. Thus, where one game story generated based on game actions initiated by a first user causes game actions to be performed relative to a game of a second user, a game story is generated to connect the first and second users.

In some embodiments, the throttle module 304 may limit or otherwise control the stories published by the game story generator 302. For example, the throttle module 304 may limit the number of stories a player may be tagged in based on a determinable threshold. In other cases, the throttle module 304 may limit the number of stories a player may publish. In some cases, the determinable threshold may be based on a game action (e.g., 10 game stories of harvesting an animal, 10 claimed item stories).

In some embodiments, the story throttle 304 may limit the publication of game stories based on social data. For example, the story throttle 304 may publish a game story tagging another player if the two players are “close” friends. Two players are close friends, in some embodiments, if they have a determinable pattern of interactions. For example, if the two player have a determinable number of interactions within a time period (>10 interactions per week). An interaction may be a game action initiated by one player that benefits or requests action of the other player. For example, a first player visiting the game board associated with the second player and harvesting a number of crops on behalf of the second player is an example of an interaction. Sending a request to help in a task is another example of an interaction.

In some cases, the story throttle 304 may filter game stories initiated by a first player that tags a second player if the story throttle 304 determines that the first and second players are not close. For example, where one player sends a number of requests to the second player but the second player responds infrequently (as may be measured by a threshold response rate) is an example where the two player may be determined to be not close.

### Example Game Systems, Social Networks, and Social Graphs

As described above, the systems described herein may include, communicate, or otherwise interact with a game system. As such, the game system is now described to illustrate further embodiments. In an online multiuser game, users control player characters (PCs), a game engine controls non-player characters (NPCs), and the game engine also manages player character state and tracks states for currently active (e.g., online) users and currently inactive (e.g., offline) users.

A player character may have a set of attributes and a set of friends associated with the player character. As used herein, the terms “state” and “attribute” can be used interchangeably to refer to any game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state, and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a user (or a group of more than one users), the game engine may take into account the state of the player character (or group of player characters (PCs)) that is playing, but also the state of one or more PCs of offline/inactive users who are connected to the current user (or PC, or group of PCs) through the game social graph but are not necessarily involved in the game at the time.

For example, User A with six friends on User A's team (e.g., the friends that are listed as being in the user's mob/gang/set/army/business/crew/etc., depending on the nature of the game) may be playing the virtual game and choose to confront User B who has 20 friends on User B's team. In some embodiments, a user may only have first-degree friends on the user's team. In other embodiments, a user may also have second-degree and higher degree friends on the user's team. To resolve the game event, in some embodiments, the game engine may total up the weapon strength of the seven members of User A's team and the weapon strength of the 21 members of User B's team and decide an outcome of the confrontation based on a random variable applied to a probability distribution that favors the side with the greater total. In some embodiments, all of this may be done without any other current active participants other than User A (e.g., User A's friends, User, B, and User B's friends could all be offline or inactive). In some embodiments, the friends in a user's team may see a change in their state as part of the outcome of the game event. In some embodiments, the state (e.g., assets, condition, level) of friends beyond the first degree are taken into account.

### Example Gaming Platforms

A virtual game may be hosted by the gaming platform 112, which can be accessed using any suitable connection with a suitable client device 104. A user may have a game account on the gaming platform 112, wherein the game account may contain a variety of information associated with the user (e.g., the user's personal information, financial information, purchase history, player character state, game state, etc.). In some embodiments, a user 102 may play multiple games on the gaming platform 112, which may maintain a single game account for the user with respect to the multiple games, or multiple individual game accounts for each game with respect to the user. In some embodiments, the gaming platform 112 may assign a unique identifier to a user 102 of a virtual game hosted on the gaming platform 112. The gaming platform 112 may determine that the user 102 is accessing the virtual game by reading the user's cookies, which may be appended to HTTP requests transmitted by the client device 104, and/or by the user 102 logging onto the virtual game.

In some embodiments, the user 102 accesses a virtual game and controls the game's progress via the client device 104 (e.g., by inputting commands to the game at the client device 104). The client device 104 can display the game interface, receive inputs from the user 102, transmit user inputs or other events to the game engine, and receive instructions from the game engine. The game engine can be executed on any suitable system (such as, for example, the client device 104, the social networking system 108, or the gaming platform 112). For example, the client device 104 may download client components of a virtual game, which are executed locally, while a remote game server, such as the gaming platform 112, provides backend support for the client components and may be responsible for maintaining application data of the game, processing the inputs from the user 102, updating and/or synchronizing the game state based on the game logic and each input from the user 102, and transmitting instructions to the client device 104. As another example, when the user 102 provides an input to the game through the client device 104 (such as, for example, by typing on the keyboard or clicking the mouse of the client device 104), the client components of the game may transmit the user's input to the gaming platform 112.

In some embodiments, the user 102 accesses particular game instances of a virtual game. A game instance is a copy of a specific game play area that is created during runtime. In some embodiments, a game instance is a discrete game play area where one or more users 102 can interact in synchronous or asynchronous play. A game instance may be, for example, a level, zone, area, region, location, virtual space, or other suitable play area. A game instance may be populated by one or more game objects. Each object may be defined within the game instance by one or more variables, such as, for example, position, height, width, depth, direction, time, duration, speed, color, and other suitable variables.

In some embodiments, a specific game instance may be associated with one or more specific users. A game instance is associated with a specific user when one or more game parameters of the game instance are associated with the specific user. For example, a game instance associated with a first user may be named “First User's Play Area.” This game instance may be populated with the first user's PC and one or more game objects associated with the first user.

In some embodiments, a game instance associated with a specific user is only accessible by that specific user. For example, a first user may access a first game instance when playing a virtual game, and this first game instance may be inaccessible to all other users. In other embodiments, a game instance associated with a specific user is accessible by one or more other users, either synchronously or asynchronously with the specific user's game play. For example, a first user may be associated with a first game instance, but the first game instance may be accessed by all first-degree friends in the first user's social network.

In some embodiments, the set of game actions available to a specific user is different in a game instance that is associated with this user compared to a game instance that is not associated with this user. The set of game actions available to a specific user in a game instance associated with this user may be a subset, superset, or independent of the set of game actions available to this user in a game instance that is not associated with him. For example, a first user may be associated with Blackacre Farm in an online farming game, and may be able to plant crops on Blackacre Farm. If the first user accesses a game instance associated with another user, such as Whiteacre Farm, the game engine may not allow the first user to plant crops in that game instance. However, other game actions may be available to the first user, such as watering or fertilizing crops on Whiteacre Farm.

In some embodiments, a game engine interfaces with a social graph. Social graphs are models of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

In some embodiments, the social graph is managed by the gaming platform 112, which is managed by the game operator. In other embodiments, the social graph is part of a social networking system 108 managed by a third party (e.g., Facebook, Friendster, Myspace). In yet other embodiments, the user 102 has a social network on both the gaming platform 112 and the social networking system 108, wherein the user 102 can have a social network on the gaming platform 112 that is a subset, superset, or independent of the user's social network on the social networking system 108. In such combined systems, gaming platform 112 can maintain social graph information with edge-type attributes that indicate whether a given friend is an “in-game friend,” an “out-of-game friend,” or both. The various embodiments disclosed herein are operable when the social graph is managed by the social networking system 108, the gaming platform 112, or both.

### Example Systems and Methods

Returning to FIG. 2, the User Player may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to Player 201. As used herein, the terms “user” and “player” can be used interchangeably and can refer to any user in an online multiuser game system or social networking system. As used herein, the term “friend” can mean any node within a user's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 11 211 and Friend 21 221. In the social graph 200, it is possible for individuals to be connected to other individuals through their first-degree friends (e.g., friends of friends). As described above, the number of edges in a minimum path that connects a user to another user is considered the degree of separation. For example, FIG. 2 shows that Player 201 has three second-degree friends to which Player 201 is connected via Player 201's connection to Player 201's first-degree friends. Second-degree Friend 8 212 and Friend 22 222 are connected to Player 201 via Player 201's first-degree Friend 11 211. The limit on the depth of friend connections, or the number of degrees of separation for associations, that Player 201 is allowed is typically dictated by the restrictions and policies implemented by the social networking system 108.

In various embodiments, Player 201 can have Nth-degree friends connected to him through a chain of intermediary degree friends as indicated in FIG. 2. For example, Nth-degree Friend 1N 219 is connected to Player 201 within in-game social network 260 via second-degree Friend 32 232 and one or more other higher-degree friends.

In some embodiments, a user (or player character) has a social graph within an online multiuser game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 11 211 and Friend 21 221 are first-degree friends with Player 201 in Player 201's out-of-game social network 250. Player 201 also has in-game connections 265 to a plurality of users, forming in-game social network 260. Here, Friend 21 221, Friend 31 231, and Friend 41 241 are first-degree friends with Player 201 in Player 201's in-game social network 260. In some embodiments, a game engine can access in-game social network 260, out-of-game social network 250, or both.

In some embodiments, the connections in a user's in-game social network is formed both explicitly (e.g., when users “friend” each other) and implicitly (e.g., when the system observes user behaviors and “friends” users to each other). Unless otherwise indicated, reference to a friend connection between two or more users can be interpreted to cover both explicit and implicit connections, using one or more social graphs and other factors to infer friend connections. The friend connections can be unidirectional or bidirectional. It is also not a limitation of this description that two users who are deemed “friends” for the purposes of this disclosure are not friends in real life (e.g., in disintermediated interactions or the like), but that can be the case.

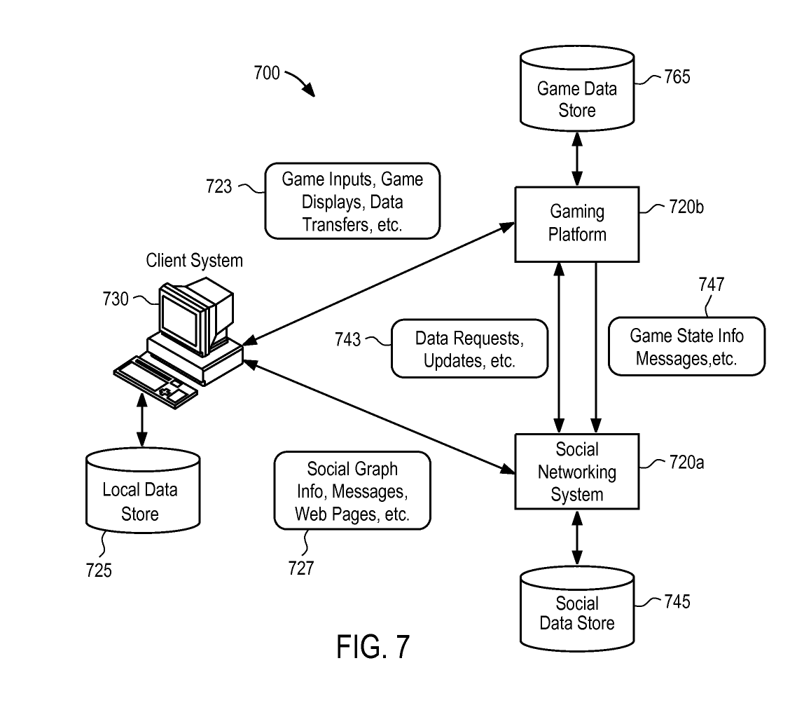

FIG. 7 illustrates an example data flow between example components of an example system 700. One or more of the components of the example system 700 may correspond to one or more of the components of the example gaming environment 100. In some embodiments, the system 700 includes a client system 730, a social networking system 720a, and a gaming platform 720b. The components of system 700 can be connected to each other in any suitable configuration, using any suitable type of connection. The components may be connected directly or over any suitable network. The client system 730, the social networking system 720a, and the gaming platform 720b may have one or more corresponding data stores such as local data store 725, social data store 745, and game data store 765, respectively.

The client system 730 may receive and transmit data 723 to and from the gaming platform 720b. This data can include, for example, a web page, a message, a game input, a game display, a HTTP packet, a data request, transaction information, and other suitable data. At some other time, or at the same time, the gaming platform 720b may communicate data 743, 747 (e.g., game state information, game system account information, page info, messages, data requests, updates) with other networking systems, such as the social networking system 720a (e.g., Facebook, Myspace). The client system 730 can also receive and transmit data 727 to and from the social networking system 720a. This data can include, for example, web pages, messages, social graph information, social network displays, HTTP packets, data requests, transaction information, updates, and other suitable data.

Communication between the client system 730, the social networking system 720a, and the gaming platform 720b can occur over any appropriate electronic communication medium or network using any suitable communications protocols. For example, the client system 730, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the gaming platform 720b, the BLOB containing the game state for the instance corresponding to the user may be transmitted to the client system 730 for use by a client-side executed object to process. In some embodiments, the client-side executable is a FLASH-based game, which can de-serialize the game state data in the BLOB. As a user plays the game, the game logic implemented at the client system 730 maintains and modifies the various game state parameters locally. The client-side game logic may also batch game events, such as mouse clicks, and transmit these events to the gaming platform 720b. Gaming platform 720b may itself operate by retrieving a copy of the BLOB from a database or an intermediate memory cache (memcache) layer. The gaming platform 720b can also de-serialize the BLOB to resolve the game state parameters and execute its own game logic based on the events in the batch file of events transmitted by the client to synchronize the game state on the server side. The gaming platform 720b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 730. For example, a client application downloaded to the client system 730 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages are associated with or accessed by the social networking system 720a. This disclosure contemplates using any suitable application for the retrieval and rendering of structured documents hosted by any suitable network-addressable resource or website.

Application event data of a game is any data relevant to the game (e.g., user inputs). In some embodiments, each application datum may have a name and a value, and the value of the application datum may change (e.g., be updated) at any time. When an update to an application datum occurs at the client system 730, either caused by an action of a game user or by the game logic itself, the client system 730 may need to inform the gaming platform 720b of the update. For example, if the game is a farming game with a harvest mechanic (such as Zynga FarmVille), an event can correspond to a user clicking on a parcel of land to harvest a crop. In such an instance, the application event data may identify an event or action (e.g., harvest) and an object in the game to which the event or action applies.

In some embodiments, one or more objects of a game are represented as an Adobe Flash object. Flash may manipulate vector and raster graphics, and supports bidirectional streaming of audio and video. “Flash” may mean the authoring environment, the user, or the application files. In some embodiments, the client system 730 may include a Flash client. The Flash client may be configured to receive and run the Flash application or game object code from any suitable networking system (such as, for example, the social networking system 720a or the gaming platform 720b). In some embodiments, the Flash client is run in a browser client executed on the client system 730. A user can interact with Flash objects using the client system 730 and the Flash client. The Flash objects can represent a variety of game objects. Thus, the user may perform various game actions on various game objects by making various changes and updates to the associated Flash objects.

In some embodiments, game actions are initiated by clicking or similarly interacting with a Flash object that represents a particular game object. For example, a user can interact with a Flash object to use, move, rotate, delete, attack, shoot, or harvest a game object. This disclosure contemplates performing any suitable game action by interacting with any suitable Flash object. In some embodiments, when the user makes a change to a Flash object representing a game object, the client-executed game logic may update one or more game state parameters associated with the game object. To ensure synchronization between the Flash object shown to the user at the client system 730, the Flash client may send the events that caused the game state changes to the game object to the gaming platform 720b. However, to expedite the processing and hence the speed of the overall gaming experience, the Flash client may collect a batch of some number of events or updates into a batch file. The number of events or updates may be determined by the Flash client dynamically or determined by the gaming platform 720b based on server loads or other factors. For example, client system 730 may send a batch file to the gaming platform 720b whenever 70 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 730, the gaming platform 720b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, gaming platform 720b may retrieve the corresponding BLOB from the database to determine the most-recent values of the game-related data. In some embodiments, while a user is playing the virtual game, the gaming platform 720b also loads the corresponding BLOB into a memory cache so that the game system may have faster access to the BLOB and the game-related data contained therein.

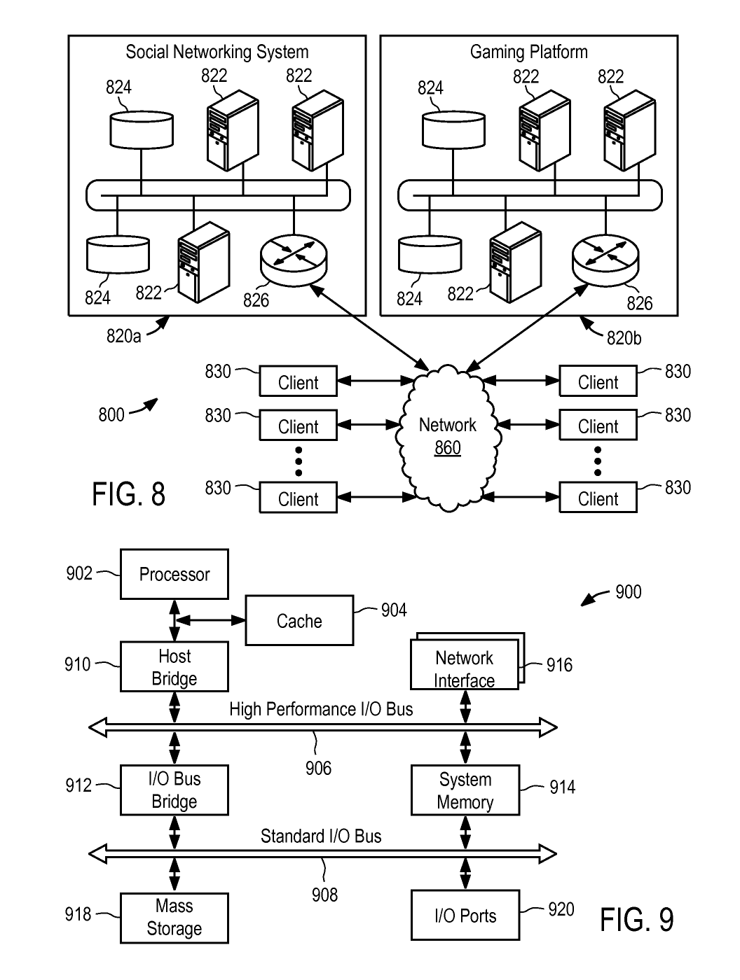

Various embodiments may operate in a wide area network environment, such as the Internet, including multiple network addressable systems. FIG. 8 illustrates an example network environment 800, in which various example embodiments may operate. Network cloud 860 generally represents one or more interconnected networks, over which the systems and hosts described herein can communicate. The network cloud 860 may include packet-based WANs (such as the Internet), private networks, wireless networks, satellite networks, cellular networks, paging networks, and the like. As FIG. 8 illustrates, various embodiments may operate in a network environment 800 comprising one or more networking systems, such as a social networking system 820a, a gaming platform 820b, and one or more client systems 830. The components of the social networking system 820a and the gaming platform 820b operate analogously; as such, hereinafter they may be referred to simply as the networking system 820. The client systems 830 are operably connected to the network environment 800 via a network service provider, a wireless carrier, or any other suitable means.

The networking system 820 is a network addressable system that, in various example embodiments, comprises one or more physical servers 822 and data stores 824. The one or more physical servers 822 are operably connected to the computer network cloud 860 via, by way of example, a set of routers and/or networking switches 826. In an example embodiment, the functionality hosted by the one or more physical servers 822 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 822 may host functionality directed to the operations of the networking system 820. Hereinafter, the servers 822 may be referred to as server 822, although the server 822 may include numerous servers hosting, for example, the networking system 820, as well as other content distribution servers, data stores, and databases. The data store 824 may store content and data relating to, and enabling operation of, the networking system 820 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like.

Logically, the data store 824 corresponds to one or more of a variety of separate and integrated databases, such as relational databases and object-oriented databases, that maintain information as an integrated collection of logically related records or files stored on one or more physical systems. Structurally, the data store 824 may generally include one or more of a large class of data storage and management systems. In some embodiments, the data store 824 may be implemented by any suitable physical system(s) including components, such as one or more database servers, mass storage media, media library systems, storage area networks, data storage clouds, and the like. In one example embodiment, the data store 824 includes one or more servers, databases (e.g., MySQL), and/or data warehouses. Data store 824 may include data associated with different networking system 820 users and/or client systems 830.

The client system 830 is generally a computer or computing device including functionality for communicating (e.g., remotely) over a computer network. The client system 830 may be a desktop computer, laptop computer, PDA, in- or out-of-car navigation system, smart phone or other cellular or mobile phone, or mobile gaming device, among other suitable computing devices. The client system 830 may execute one or more client applications, such as a Web browser.

When a user at the client system 830 desires to view a particular webpage (hereinafter also referred to as target structured document) hosted by the networking system 820, the user's web browser, or other document rendering engine or suitable client application, formulates and transmits a request to the networking system 820. The request generally includes a URL or other document identifier as well as metadata or other information. By way of example, the request may include information identifying the user, a timestamp identifying when the request was transmitted, and/or location information identifying a geographic location of the user's client system 830 or a logical network location of the user's client system 830.

Although the example network environment 800 described above and illustrated in FIG. 8 is described with respect to the social networking system 820a and the gaming platform 820b, this disclosure encompasses any suitable network environment using any suitable systems. For example, a network environment may include online media systems, online reviewing systems, online search engines, online advertising systems, or any combination of two or more such systems.

FIG. 9 illustrates an example computing system architecture, which may be used to implement a server 822 or a client system 830. In one embodiment, the hardware system 900 comprises a processor 902, a cache memory 904, and one or more executable modules and drivers, stored on a tangible computer-readable storage medium, directed to the functions described herein. Additionally, the hardware system 900 may include a high performance input/output (I/O) bus 906 and a standard I/O bus 908. A host bridge 910 may couple the processor 902 to the high performance I/O bus 906, whereas the I/O bus bridge 912 couples the two buses 906 and 908 to each other. A system memory 914 and one or more network/communication interfaces 916 may couple to the bus 906. The hardware system 900 may further include video memory (not shown) and a display device coupled to the video memory. Mass storage 918 and I/O ports 920 may couple to the bus 908. The hardware system 900 may optionally include a keyboard, a pointing device, and a display device (not shown) coupled to the bus 908. Collectively, these elements are intended to represent a broad category of computer hardware systems.

The elements of the hardware system 900 are described in greater detail below. In particular, the network interface 916 provides communication between the hardware system 900 and any of a wide range of networks, such as an Ethernet (e.g., IEEE 802.3) network, a backplane, and the like. The mass storage 918 provides permanent storage for the data and programming instructions to perform the above-described functions implemented in servers 922 of FIG. 8, whereas system memory 914 (e.g., DRAM) provides temporary storage for the data and programming instructions when executed by the processor 902. I/O ports 920 are one or more serial and/or parallel communication ports that provide communication between additional peripheral devices, which may be coupled to the hardware system 900.

The hardware system 900 may include a variety of system architectures, and various components of the hardware system 900 may be rearranged. For example, cache memory 904 may be on-chip with the processor 902. Alternatively, the cache memory 904 and the processor 902 may be packed together as a “processor module,” with processor 902 being referred to as the “processor core.” Furthermore, certain embodiments of the present disclosure may neither require nor include all of the above components. For example, the peripheral devices shown coupled to the standard I/O bus 908 may couple to the high performance I/O bus 906. In addition, in some embodiments, only a single bus may exist, with the components of the hardware system 900 being coupled to the single bus. Furthermore, the hardware system 900 may include additional components, such as additional processors, storage devices, or memories.

An operating system manages and controls the operation of the hardware system 900, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments, the term “web service” and “website” may be used interchangeably and additionally may refer to a custom or generalized API on a device, such as a mobile device (e.g., cellular phone, smart phone, personal GPS, PDA, personal gaming device, etc.), that makes API calls directly to a server. Still further, while the embodiments described above operate with game challenges (as may be provided through a quest mechanic), the embodiments can be applied to communication targeted to a user, such as an advertisement, notification, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A method comprising:
responsive to detecting a first game action initiated by a first user, surfacing a first game story to a second user through a social feed; and
responsive to detecting the first game story being activated by the second user through the social feed, surfacing, to the first user, a second game story on the social feed that includes a tag to the first user, the second game story representing a second game action being performed in a game involving the second user based on the first game story being activated.

2. The method of claim 1, wherein the second game action rewards a game object to the first user.

3. The method of claim 1, wherein the social feed is at least one of: a news feed, a timeline, a canvas ticker, or a homepage ticker.

4. The method of claim 1, wherein the social feed is hosted by a social networking system.

5. The method of claim 1, wherein the surfacing of the second game story on the social feed includes sending game story data through an application programming interface implemented by a social networking system.

6. The method of claim 1, wherein the surfacing of the second game story on the social feed includes determining that the first user satisfies a throttling condition.

7. The method of claim 6, wherein the throttling condition compares a rate of closed loop communication between the first user and the second user.

8. The method of claim 7, wherein the throttling condition determines whether the first user and the second user are close friends.

9. The method of claim 6, wherein the throttling condition compares a number of incidents in which the first user has been tagged in game stories over a time period.

10. The method of claim 1, wherein the first game story includes game hook data that is configured to cause a game engine to perform a game action when activated by the second user.

11. A computer system comprising:
a game story generator implemented by one or more processors and configured to:
responsive to detecting a first game action initiated by a first user, surface a first game story to a second user through a social feed; and
responsive to detecting the first game story being activated by the second user through the social feed, surface, to the first user, a second game story on the social feed that includes a tag to the first user, the second game story representing a second game action being performed in a game involving the second user based on the first game story being activated.

12. The computer system of claim 11, wherein the second game action rewards a game object to the first user.

13. The computer system of claim 11, wherein the social feed is at least one of: a news feed, a timeline, a canvas ticker, or a homepage ticker.

14. The computer system of claim 11, wherein the social feed is hosted by a social networking system.

15. The computer system of claim 11, wherein the surfacing of the second game story on the social feed includes sending game story data through an application programming interface implemented by a social networking system.

16. The computer system of claim 11, wherein the surfacing of the second game story on the social feed includes determining that the first user satisfies a throttling condition.

17. The computer system of claim 16, wherein the throttling condition compares a rate of closed loop communication between the first user and the second user.

18. The computer system of claim 17, wherein the throttling condition determines whether the first user and the second user are close friends.

19. The computer system of claim 16, wherein the throttling condition compares a number of incidents in which the first user has been tagged in game stories over a time period.

20. A non-transitory computer-readable medium storing executable instructions thereon, which, when executed by a processor, cause the processor to perform operations comprising:
responsive to detecting a first game action initiated by a first user, surfacing a first game story to a second user through a social feed; and
responsive to detecting the first game story being activated by the second user through the social feed, surfacing, to the first user, a second game story on the social feed that includes a tag to the first user, the second game story representing a second game action being performed in a game involving the second user based on the first game story being activated.
